(19) United States
(12) Patent Application Publication
(10) Pub. No.: US 2021/0376532 A1
(43) Pub. Date: Dec. 2, 2021

(54) PLUG CONNECTOR AND PLUG CONNECTOR SYSTEM

(71) Applicants: PHOENIX CONTACT GMBH & CO. KG, Blomberg (DE); EPT GMBH, Peiting (DE)

(72) Inventors: Arndt Schafmeister, Dörentrup (DE); Nico Wassel, Blomberg (DE); Alexander Herbst, Blomberg (DE); Kathrin Stelzer, Paderborn (DE); Dimitri Hardt, Paderborn (DE); Ralf Geske, Schieder-Schwalenberg (DE); Ralf Gehle, Detmold (DE); Markus Sonderer, Höxter (DE); Sven Hergesell, Hameln (DE); Ralph Habiger, Hohenfurch (DE); Claus Guglhör, Schwangau (DE)

(21) Appl. No.: 17/292,255

(22) PCT Filed: Oct. 30, 2019
(86) PCT No.: PCT/EP2019/079706

§ 371 Date: May 7, 2021

(30) Foreign Application Priority Data
Nov. 7, 2018 (DE) 10 2018 127 815.2

(51) Int. Cl. H01R 13/6582; H01R 13/64; H01R 13/516; H01R 13/629

(52) U.S. Cl. CPC H01R 13/6582; H01R 13/629; H01R 13/516; H01R 13/64

(57) ABSTRACT

The invention relates to a plug connector comprising a housing (8) and at least one contact (10) which is held on the housing (8) and which is designed to contact a contact (10) of another plug connector (6), wherein the housing (8) has at least one shaped element (12) for securing at least one shield plate (30, 32). The invention is characterized in that the housing (8) has at least one guide element (14, 16) which is designed to guide and position the plug connector (4) on another plug connector (6) in a form-fitting manner, said guide element (14, 16) being arranged at a distance from the shaped element (12).

The present invention relates to a plug connector comprising a housing and at least one contact which is held on the housing and which is designed to contact a contact of another plug connector, the housing having at least one shaped element for securing at least one shield plate. The invention also relates to a plug connector system having such a plug connector.

Plug connectors and plug connector systems of the type mentioned at the outset can be provided as shielded solutions having shield plates. In this case, the shield plates are usually integrated into the design such that, when a plug connector is brought together with its associated counterpart, the shield plates are used to guide and position the two plug components of such a plug connector system. The shield plates are used to shield the contacts of the plug connector and its associated mating connector that are in contact with one another.

If a plug connector system or a plug connector without shield plates is provided, a separate housing design is usually required for this purpose, which housing design takes over the guidance and positioning when plugging together, since no shield plates are present.

Accordingly, separate housings and corresponding injection molding tools for plug connectors and mating connectors of shielded systems and for plug connectors and mating plugs of unshielded systems have to be kept ready for the production thereof, since the housing designs differ significantly.

Against this background, the technical problem addressed by the present invention is that of specifying an improved plug connector and an improved plug connector system of the type mentioned at the outset, which do not have the above-described disadvantages, or at least to a lesser extent, and in particular make it possible for shielded and unshielded plug-connectors and plug connector systems to be provided in a more cost-effective manner.

The present technical problem described above is solved in each case by a plug connector according to claim 1 and a plug connector system according to claim 11. Further embodiments of the invention can be found in the dependent claims and the following description.

According to a first aspect, the invention relates to a plug connector comprising a housing and at least one contact which is held on the housing and which is designed to contact a contact of another plug connector, the housing having at least one shaped element for securing at least one shield plate. The housing has at least one guide element for guiding and positioning the plug connector in a form-fitting manner, which guide element is formed on a further plug connector, the guide element being arranged at a distance from the shaped element.

The arrangement of the shield plates, which is possible if required, is therefore provided independently and separately from the guidance and positioning aid in the form of the guide element on the plug connector. The plug connector can therefore be equipped with shield plates on the housing, if necessary, but is also fully functional without mounted shield plates and can also be reliably positioned and oriented on another plug connector without shield plates by means of the guide element.

When a shield plate is referred to in the present case, this is in particular a metal component for shielding the likewise preferably metal contact. The contact is used to establish an electrically conductive connection by abutting the further metal contact of the further plug connector.

The plug connector is therefore in particular designed to establish a detachable plug connection to the further plug connector.

The plug connector housing can be partially or completely made of an electrically insulating plastics material.

According to a further embodiment of the invention, the guide element can be a projection or a mandrel, the projection or mandrel being designed to form-fittingly engage in a complementarily shaped guide element of the further plug connector, such as a groove, a recess or the like.

By means of these shaped elements, predetermined guidance during an insertion movement as well as a defined orientation and positioning of the plug connectors to be connected can be achieved in a simple and cost-effective manner.

The projection or mandrel can in particular have an end bevel or taper in order to simplify threading into an associated groove or recess.

Alternatively, the guide element can be a groove or a recess, the groove or recess being designed to form-fittingly receive a complementarily shaped guide element of the further plug connector, such as a projection, a mandrel or the like.

In particular, a linear guide can be formed by the guide elements, which linear guide predefines a rectilinear insertion of the plug connector into the further plug connector, or vice versa. The associated guide elements, as soon as they are in engagement, therefore only allow one degree of freedom along a rectilinear insertion movement in order to achieve reliable contact with the associated contacts.

In order to provide a cost-effective guide which can be produced in a simple manner, the guide element can be an integral part of an outer wall of the housing, the outer wall circumferentially enclosing the contact. In this way, the guide element can be provided such that the installation space for arranging one or more contacts of the plug connector is not restricted.

In order to make a design of a linear guide in particular possible, at least two or precisely two guide elements can be provided.

In particular, the guide elements can be arranged so as to be distributed asymmetrically, such that a mechanical coding results which excludes improper assembly with incorrect orientation.

If at least two or precisely two guide elements are provided, for the purpose of mechanical coding, a guide element can, for example, have dimensions which differ from the dimensions of a further guide element.

Alternatively or in addition, the guide elements can also be arranged so as to be offset or distributed such that mechanical coding is formed by the arrangement.

According to a further embodiment of the plug connector, a first guide element can be formed on a first wall portion of the housing and a second guide element can be formed on a second wall portion of the housing, the first wall portion and the second wall portion being arranged at a distance from one another and arranged on opposite housing sides. In this way it can be achieved that the guide elements are at the greatest possible distance from one another on the housing in order to prevent tilting when the plug connector is joined to the further plug connector, such that a plug connection that is easy and reliable to mount is provided.

The housing can be substantially cuboid in order to make a simple arrangement of even a plurality of contacts in an interior of the housing possible.

The shaped element for securing the shield plate can be formed on a third wall portion of the housing, the third wall portion connecting the first and second wall portions to one another. The distance between the shaped elements and the guide elements can ensure that guidance and positioning take place independently of the shield plates, since these are, if necessary, arranged on a wall portion of the housing that is separate from the guide element.

According to a further embodiment of the plug connector, the housing has two or more shaped elements which are provided for securing two or more shield plates or precisely two shield plates to a housing. The plug connector can therefore be fitted with shield plates on the shaped elements, as required, or is used as an unshielded plug connector independently of the shield plates.

The guide element can have a height which is measured along an insertion direction of the further plug connector into the plug connector and which is more than half the total height of the housing. Reliable guidance and positioning of the plug connector relative to the further plug connector can thus be achieved.

Alternatively or in addition, the guide element can have a width which is measured perpendicularly to an insertion direction of the further plug connector into the plug connector and which is more than a quarter of the total width of the housing. In this way, a robust guide element for positioning and guiding the plug connector while the further plug connector is moving can be achieved.

At least one shield plate can be held on the shaped element, the shield plate in particular being at a distance from the guide element. If a shield plate or a plurality of shield plates or, for example, exactly two shield plates are provided on the housing of the plug connector, reliable positioning and guidance of the plug connector during a relative movement of a further plug connector to be connected can therefore continue to be achieved independently of the mounting of the shield plate.

According to a second aspect, the invention relates to a plug connector system comprising a first plug connector according to the invention and a second plug connector which is formed as a mating connector to the first plug connector.

The plug connectors can each have a plurality of contacts which, if the plug connectors are in engagement with one another, establish an electrically conductive connection by in particular resting against one another so as to be braced in a resiliently elastic manner.

The plug connectors in particular have guide elements which form a linear guide for joining or pulling apart the plug connectors in a rectilinear manner. The guide elements are in particular arranged at such a distance from the shield plates mounted if necessary that the linear guide is formed independently of the mounted shield plates.

The invention is described in greater detail in the following with reference to drawings showing embodiments, in which, schematically:

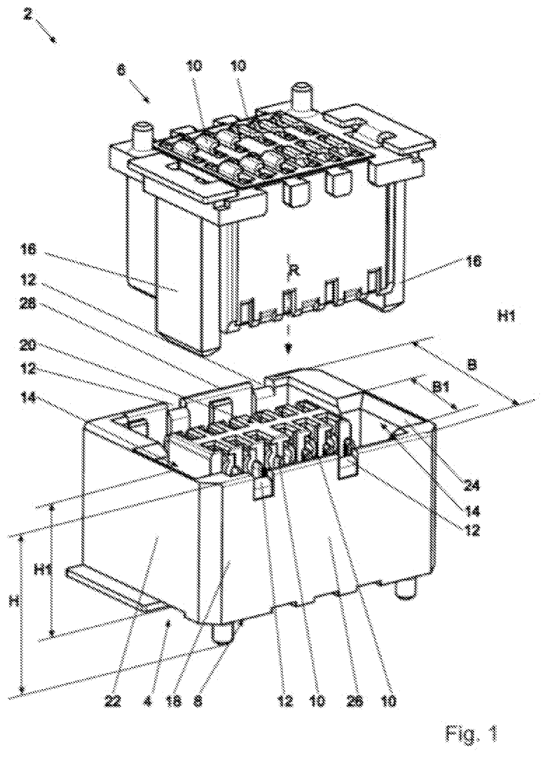

FIG. 1 shows a first plug connector system according to the invention comprising a plug connector according to the invention;

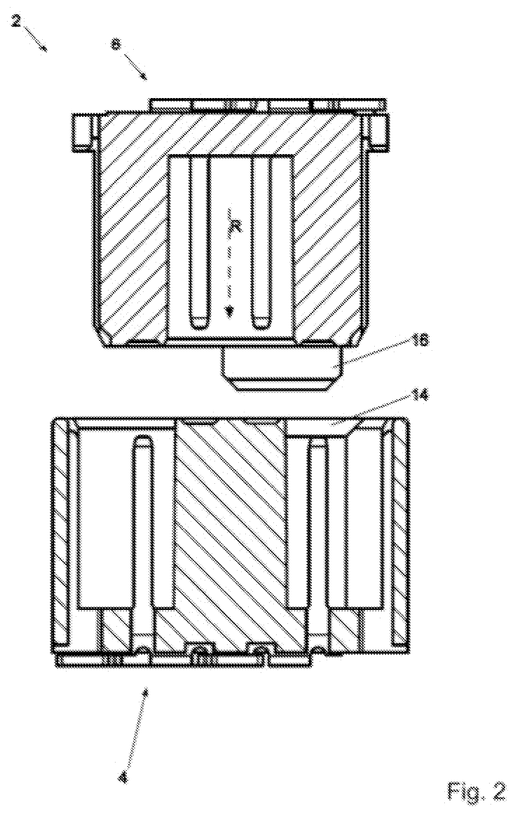

FIG. 2 is a cross section of the plug connector system from FIG. 1;

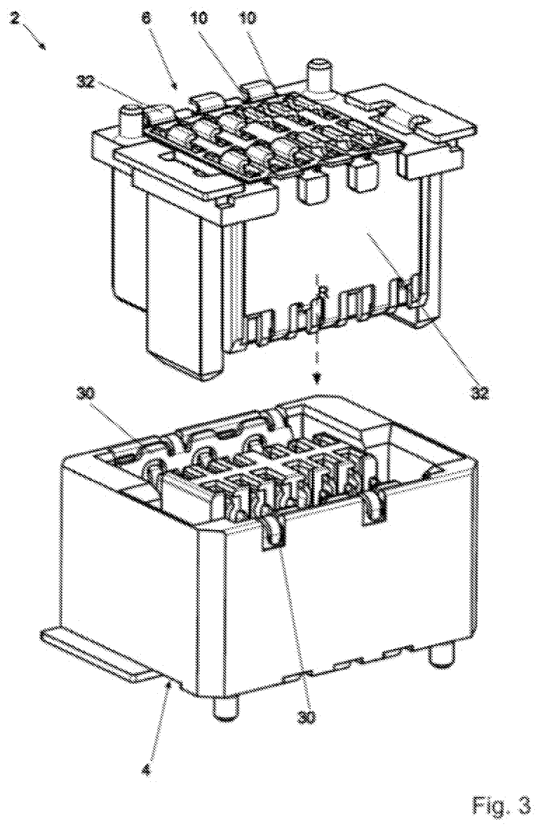

FIG. 3 shows a second plug connector system according to the invention comprising a plug connector according to the invention;

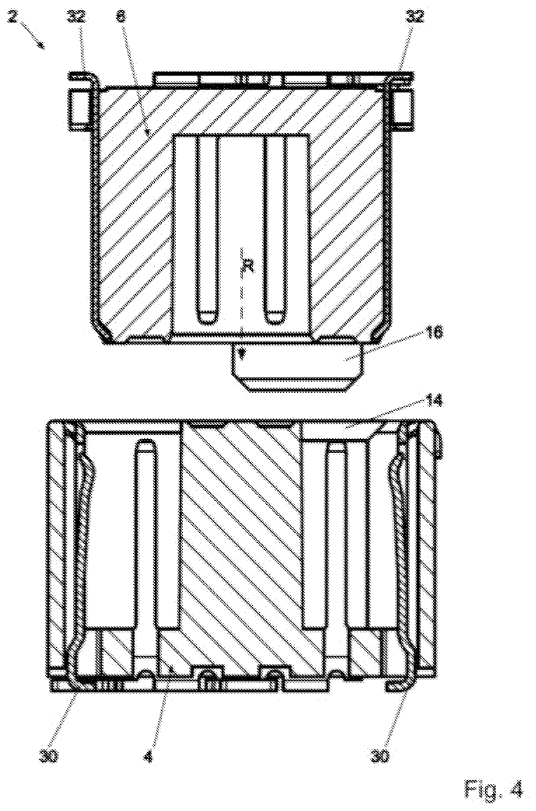

FIG. 4 is a cross section of the plug connector system from FIG. 3;

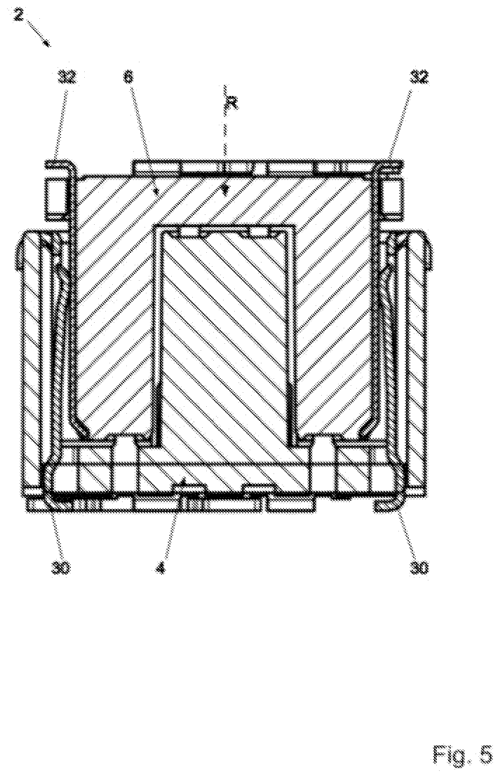

FIG. 5 shows the plug connectors from FIG. 4 in the inserted state;

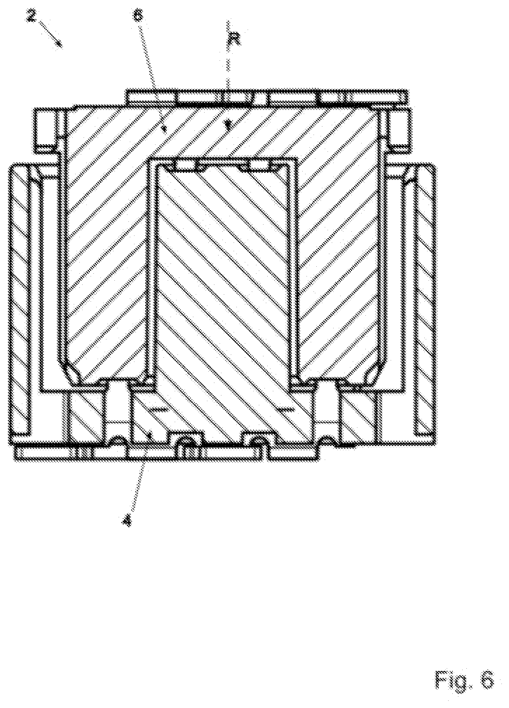

FIG. 6 shows the plug connectors from FIG. 3 in the inserted state.

FIG. 1 is a perspective view of a plug connector system 2 according to the invention. The plug connector system 2 has a plug connector 4 according to the invention and a second plug connector 6 according to the invention that is formed as a mating connector 6 to the first plug connector 4.

The plug connector 4 has a housing 8 and a plurality of contacts 10 held on the housing 8. The contacts 10 are metal contacts, of which only two of the twelve pieces of the first plug connector 4 shown have been provided with a reference sign 10 by way of example.

In the present case, the contacts 10 consist of a metal material.

In the present case, the housing 8 consists of an electrically insulating plastics material.

The second plug connector 6 also has metal contacts 10.

The housing has shaped elements 12 which are formed as recesses 12 and are designed to secure a shield plate (not shown). In the present case, no shield plate is mounted on the housing 8. In the present case, the housing 8 has two guide elements 14 which are designed to guide and position the plug connector 4 on the plug connector 6 in a form-fitting manner.

The guide elements 14 are arranged at a distance from the shaped elements 12.

In the present case, the guide elements 14 are each formed as a groove 14 formed in the housing 8 and are each provided for receiving a complementarily shaped projection 16 of the plug connector 6.

The guide elements 14, 16 form a linear guide which is provided for guiding a rectilinear insertion movement of the plug connector 6 into the plug connector 4 along an insertion direction R. The plug connector 6 is therefore inserted into the plug connector 4 along a rectilinear movement parallel to the insertion direction R, the guide elements 14, 16 forming a linear guide. In the present case, the housing 8 accordingly has precisely two guide elements 14.

In addition, mechanical coding is formed by the eccentric arrangement of the linear guide elements 14, 16 in order to prevent incorrect assembly.

In the present case, the guide elements 14 are an integral part of the outer wall 18 of the housing, the outer wall 18 circumferentially surrounding a branched rib region 20 of the housing 8 and the contacts. The contacts 10 are each held in a form-fitting and force-fitting manner on recesses in the inner rib region 20.

The guide elements 14 are arranged on opposite wall portions 22, 24 of the housing 8.

The shaped elements 12 for securing shield plates are formed on a third wall portion 26 and a fourth wall portion 28 of the housing 8, which connect the wall portions 22 and 24 to one another such that the housing 8 has a substantially cuboid basic structure.

The two shaped elements 12 of the fourth wall 28 are used to hold a first shield plate (not shown), the shaped elements 12 of the third wall 26 being used to hold a further shield plate (not shown). The shield plates are each hooked into the shaped elements 12 there by means of latching hooks.

The guide elements 14, viewed along the insertion direction R, extend over a height H1 which is more than half the total height H of the housing 8. The guide element 14 also has a width B1 which is measured perpendicularly to the insertion direction R and is more than a quarter of the total width B of the housing 8. These relationships likewise apply to the guide elements 16 of the plug connector 6.

FIG. 2 shows the plug connectors 4 and 6 in each case in a cross section.

FIG. 3 shows the plug connectors 4, 6 with mounted shield plates 30, 32.

FIG. 4 shows the plug connectors 4, 6 with mounted shield plates 30, 32 in a cross section.

FIG. 5 shows the plug connectors 4, 6 from FIGS. 3 and 4 in the plugged-together state.

FIG. 6 shows the plug connectors 4, 6 from FIGS. 1 and 2 without mounted shield plates in the plugged-together state.

### LIST OF REFERENCE SIGNS

2 Plug connector system
4 Plug connector
6 Plug connector
8 Housing
10 Contact
12 Shaped element
14 Guide element
16 Projection
18 Outer wall
20 Rib region
22 Wall portion
24 Wall portion
26 Wall portion
28 Wall portion
30 Shield plates
32 Shield plates
H Height
H1 Height
B Width
B1 Width
R Insertion direction

1. A plug connector
comprising a housing and
at least one contact which is held on the housing and which is designed to contact a contact of another plug connector,
the housing having at least one shaped element for securing at least one shield plate,
characterized in that
the housing has at least one guide element which is designed to guide and position the plug connector on another plug connector in a form-fitting manner,
said guide element being arranged at a distance from the shaped element.

2. The plug connector according to claim 1,
characterized in that
the guide element is a projection or a mandrel,
the projection or mandrel being designed to form-fittingly engage in a complementarily shaped guide element of the further plug connector, such as a groove, a recess or the like.

3. The plug connector according to claim 1,
characterized in that
the guide element is a groove or a recess,
the groove or recess being designed to form-fittingly receive a complementarily shaped guide element of the further plug connector, such as a projection, a mandrel or the like.

4. The plug connector according to claim 1, characterized in that
the guide element is an integral part of an outer wall of the housing,
the outer wall circumferentially enclosing the contact.

5. The plug connector according to claim 1, characterized in that
at least two or precisely two guide elements are provided.

6. The plug connector according to claim 5, characterized in that
a first guide element is formed on a first wall portion of the housing and
a second guide element is formed on a second wall portion of the housing,
the first wall portion and the second wall portion being arranged at a distance from one another and on opposite housing sides.

7. The plug connector according to claim 6,
characterized in that
the shaped element for securing the shield plate is formed on a third wall portion of the housing,
the third wall portion connecting the first and second wall portions to one another.

8. The plug connector according to claim 1, characterized in that
two or more shaped elements are provided which are provided for securing two or more shield plates or precisely two shield plates to the housing.

9. The plug connector according to claim 1, characterized in that
the guide element has a height which is measured along an insertion direction of the further plug connector into the plug connector and which is more than half the total height of the housing, and/or
in that the guide element has a width which is measured perpendicularly to an insertion direction of the further plug connector into the plug connector and which is more than a quarter of the total width of the housing.

10. The plug connector according to claim 1, characterized in that
at least one shield plate is held on the shaped element.

11. Plug A plug connector system,
comprising a first plug connector which is formed according to claim 1,
and a second plug connector which is formed as a mating connector to the first plug connector.
